(19) United States
(12) Patent Application Publication
(10) Pub. No.: US 2022/0330295 A1
(43) Pub. Date: Oct. 13, 2022

(54) MULTI-SLOT TRANSMISSIONS FOR MULTI-TRANSMISSION RECEPTION POINTS

(71) Applicant: QUALCOMM Incorporated, San Diego, CA (US)

(72) Inventors: Hung Dinh LY, San Diego, CA (US); Gokul SRIDHARAN, Sunnyvale, CA (US)

(21) Appl. No.: 17/229,559

(22) Filed: Apr. 13, 2021

(51) Int. Cl. H04W 72/12; H04W 72/04; H04L 5/00

(52) U.S. Cl. CPC H04W 72/1273; H04W 72/0446; H04W 72/0453; H04W 72/1257; H04L 5/0012

(57) ABSTRACT

Certain aspects of the present disclosure provide techniques for multi-slot transport block transmission with frequency hopping. A method that may be performed by a user equipment (UE) includes receiving scheduling for at least one transport block to be transmitted over multiple slots and transmitting the transport block on multiple transmission occasions over the multiple slots, in accordance with frequency hopping applied to vary frequency resources used across transmission occasions.

### BACKGROUND

### Field of the Disclosure

Aspects of the present disclosure relate to wireless communications, and more particularly, to techniques for implementing multi-slot transport block transmission with frequency hopping.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. These improvements should be applicable to other multi-access technologies and the telecommunication standards that employ these technologies.

### SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide advantages that include desirable coverage, reliability, and/or performance of wireless communications.

Certain aspects of the subject matter described in this disclosure can be implemented in a method for wireless communication by a user equipment (UE). The method generally includes receiving scheduling for at least one transport block to be transmitted over multiple slots and transmitting the transport block on multiple transmission occasions over the multiple slots, in accordance with frequency hopping applied to vary frequency resources used across transmission occasions.

Certain aspects of the subject matter described in this disclosure can be implemented in a method for wireless communication by a network entity. The method generally includes transmitting, to a user equipment (UE), signaling scheduling the UE to transmit at least one transport block over multiple slots and monitoring for the transport block on multiple transmission occasions over the multiple slots, in accordance with frequency hopping applied to vary frequency resources used across transmission occasions.

Certain aspects of the subject matter described in this disclosure can also be implemented in various apparatuses, means, and computer readable mediums capable of performing the operations described above and herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain aspects of this disclosure and the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIGS. 4A and 4B are diagrams illustrating examples of time-division duplex (TDD) schemes for downlink (DL) and uplink (UL) slots, in accordance with certain aspects of the present disclosure.

FIGS. 5A and 5B are diagrams illustrating various examples of transmitting a transport block over multiple slots, in accordance with certain aspects of the present disclosure.

FIG. 6 is a diagram illustrating various examples of transmitting a transport block over multiple slots with frequency hopping, in accordance with certain aspects of the present disclosure.

FIG. 7 is a flow diagram illustrating example operations for wireless communication by a UE, in accordance with certain aspects of the present disclosure.

FIG. 8 is a flow diagram illustrating example operations for wireless communication by a network entity, in accordance with certain aspects of the present disclosure.

FIG. 9 illustrates an example of frequency hop resources, in accordance with certain aspects of the present disclosure.

FIGS. 10A and 10B are slot diagrams illustrating examples of transmitting a transport block over multiple slots with frequency hopping, in accordance with certain aspects of the present disclosure.

FIG. 11 is a diagram illustrating an example of frequency hop resources within a slot or transmission occasion, in accordance with certain aspects of the present disclosure.

FIG. 12 illustrates a communications device (e.g., a UE) that may include various components configured to perform operations for the techniques disclosed herein in accordance with aspects of the present disclosure.

FIG. 13 illustrates a communications device (e.g., a BS) that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for implementing multi-slot transport block (TB) transmissions over an uplink channel with frequency hopping. The techniques described herein allow a UE and base station (e.g., gNB) to determine frequency resources for each of multiple transmissions. In some cases, the location of frequency resources for any given transmission may be determined based on a particular slot (e.g., slot index) or transmission occasion (e.g., transmission occasion index) in which the transmission is sent.

The following description provides examples of multi-slot TB transmissions with frequency hopping. Changes may be made in the function and arrangement of elements discussed without departing from the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth, millimeter wave mmW, massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

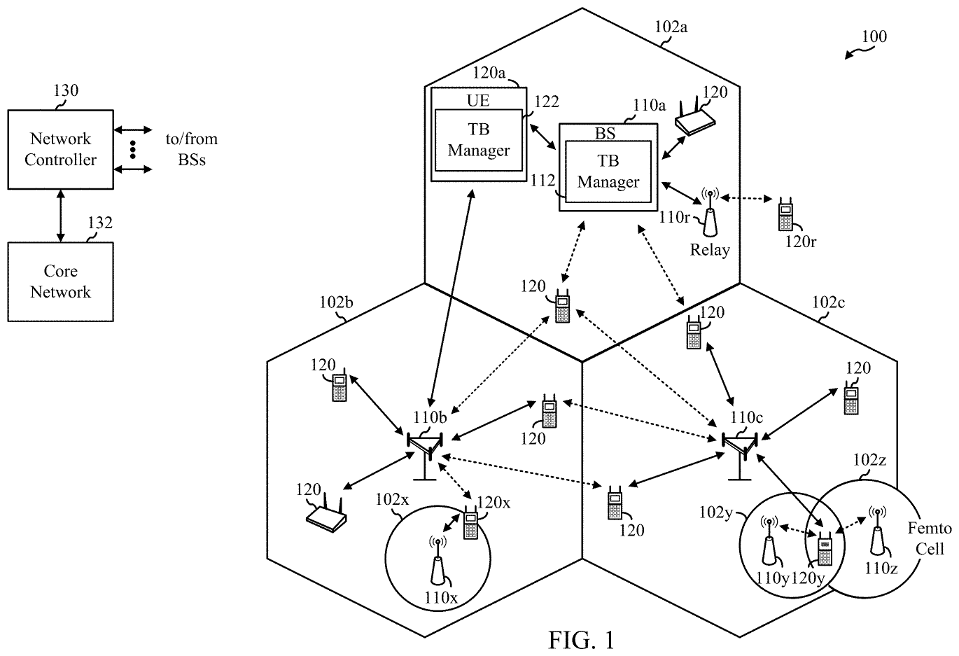

FIG. 1 illustrates an example wireless communication network 100 in which aspects of the present disclosure may be performed.

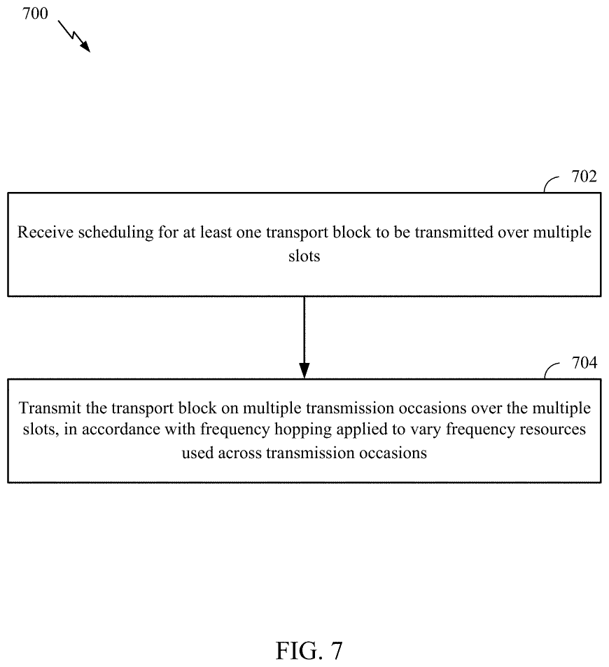

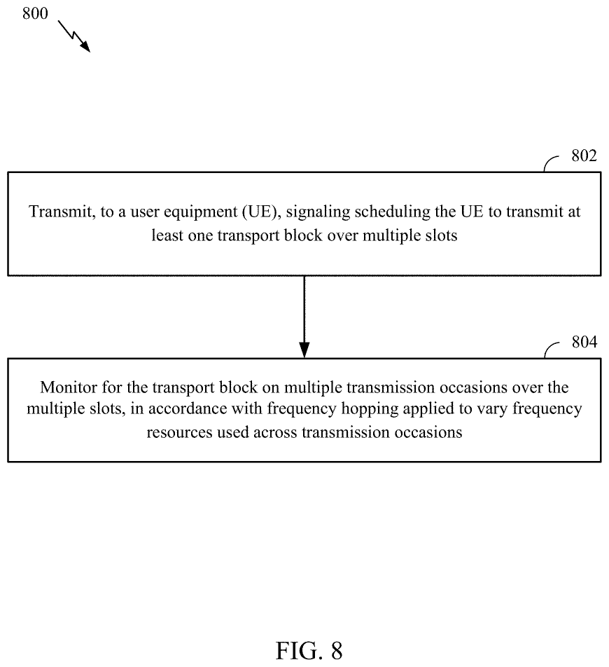

For example, the wireless communication network 100 may include a base station (BS) 110a that includes a transport block (TB) manager 112, which may be configured to perform operations 800 of FIG. 8 to schedule a UE (e.g., UE 120a) with multi-slot TB transmissions. As shown, UE 120a may also include a TB manager 122, which may be configured to perform operations 700 of FIG. 7 to receive the scheduling and transmit the TB in multiple slots with frequency hopping, in accordance with aspects of the present disclosure.

The wireless communication network 100 may be an NR system (e.g., a 5G NR network). As shown in FIG. 1, the wireless communication network 100 may be in communication with a core network 132. The core network 132 may in communication with one or more base station (BSs) 110a-z (each also individually referred to herein as BS 110 or collectively as BSs 110) and/or user equipment (UE) 120a-y (each also individually referred to herein as UE 120 or collectively as UEs 120) in the wireless communication network 100 via one or more interfaces.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120 in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In certain cases, the network controller 130 may include a centralized unit (CU) and/or a distributed unit (DU), for example, in a 5G NR system. In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

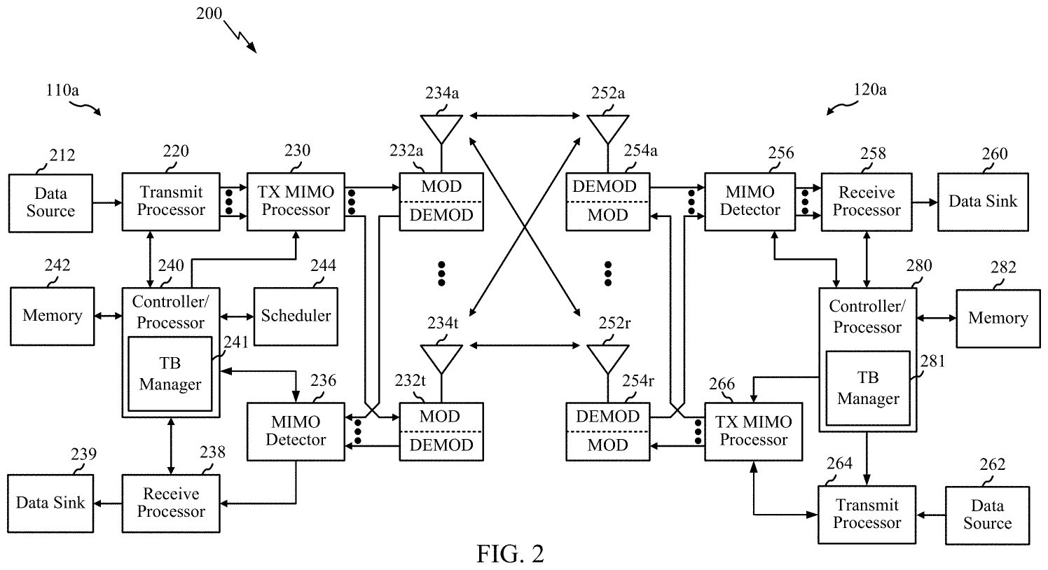

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has a TB manager 241, which may be representative of the TB manager 112, according to aspects described herein. As shown in FIG. 2, the controller/processor 280 of the UE 120a has a TB manager 281, which may be representative of the TB manager 122, according to aspects described herein. Although shown at the controller/processor, other components of the UE 120a and BS 110a may be used to perform the operations described herein.

While the UE 120a is described with respect to FIGS. 1 and 2 as communicating with a BS and/or within a network, the UE 120a may be configured to communicate directly with/transmit directly to another UE 120, or with/to another wireless device without relaying communications through a network. In some embodiments, the BS 110a illustrated in FIG. 2 and described above is an example of another UE 120.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

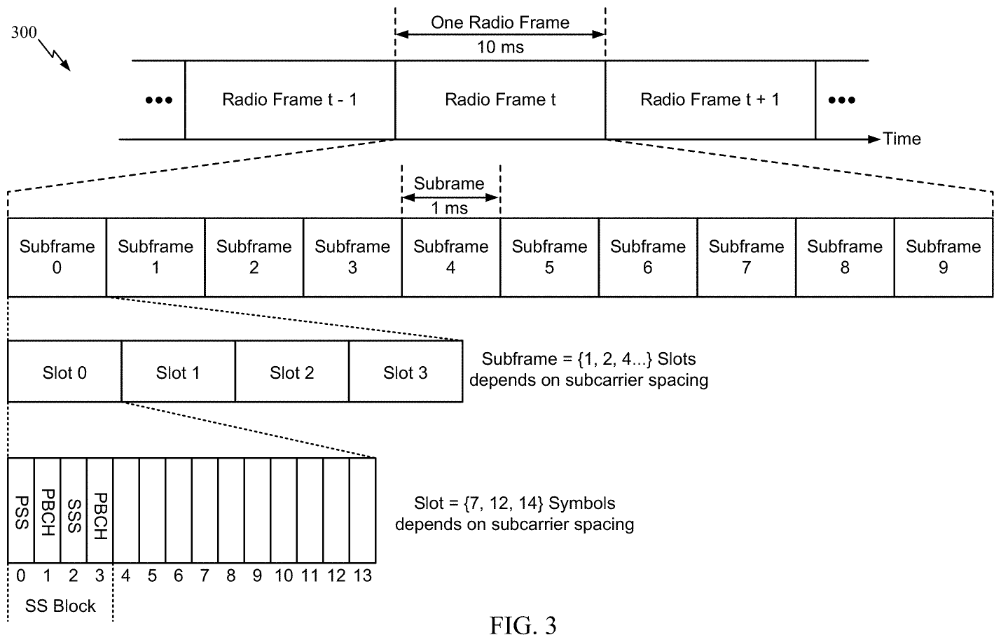

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A sub-slot structure may refer to a transmit time interval having a duration less than a slot (e.g., 2, 3, or 4 symbols). Each symbol in a slot may be configured for a link direction (e.g., downlink (DL), uplink (UL), or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst periodicity, system frame number, etc. The SSBs may be organized into an SS burst to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times within an SS burst, for example, with up to sixty-four different beam directions for mmWave. The multiple transmissions of the SSB are referred to as an SS burst in a half radio frame. SSBs in an SS burst may be transmitted in the same frequency region, while SSBs in different SS bursts can be transmitted at different frequency regions.

### Example Multi-Slot Transport Block Transmission

In certain wireless communication systems (e.g., NR), a UE may support transmission of a transport block (TB) over multiple slots (TBoMS) in the time domain. In other words, a TB may provide continuity of a data bit sequence across multiple slots. As used herein, such a TB may be referred to as a multi-slot TB transmission or a multi-slot TB.

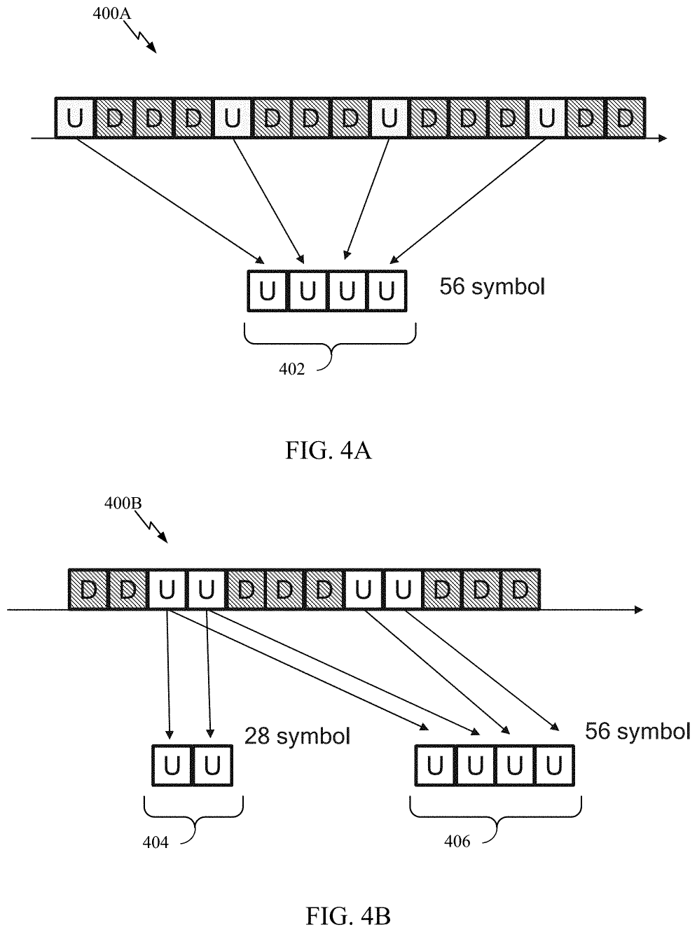

For example, FIGS. 4A and 4B illustrate examples of time-division duplex (TDD) schemes for downlink (DL) and uplink (UL) slots, in accordance with certain aspects of the present disclosure. Referring to FIG. 4A, a TDD UL-DL pattern 400A may have a periodic sequence of one UL slot followed by three DL slots. A multi-slot TB 402 may include four UL slots across the non-consecutive UL slots in the TDD UL-DL pattern 400A, and the multi-slot TB 402 may have a total of 56 symbols, for example. As shown in FIG. 4B, a TDD UL-DL pattern 400B may have a periodic sequence of two UL slots followed by three DL slots. In certain cases, a multi-slot TB 404 may include two consecutive UL slots having a total of 28 symbols. In certain aspects, a multi-slot TB 406 may include four UL slots with two pairs of consecutive UL slots having a total of 56 symbols. In other words, a multi-slot TB may include consecutive and/or non-consecutive UL slots. In certain cases, a multi-slot TB may span across multiple slots, but be less than or equal to a slot in length. The encoded payload of a TB may be transmitted based on a single redundancy version (RV). In certain cases, a TB transmission may be referred to as a transmission occasion. If repetitions are allowed, the transport block may be transmitted over multiple transmission occasions.

In general, a redundancy version (RV) in an RV sequence may span across consecutive slots (referred to as Option A) or non-consecutive slots (referred to as Option B) of a multi-slot TB. Under Option B, the UE may buffer the whole interleaved coded sequence and track the starting bit in each transmission occasion of the multi-slot TB. The RV sequence may provide the RVs used for each retransmission or repetition in a sequence of retransmissions. As an example, the RV sequence may have the following values: {0, 2, 3, 1}, {0, 3, 0, 3}, or {0, 0, 0, 0}, where each element in the sequence represents a specific RV. The RV sequence of {0, 2, 3, 1} provides that the first RV is RV0, the second RV is RV2, the third RV is RV3, and the last RV is RV1 in the sequence.

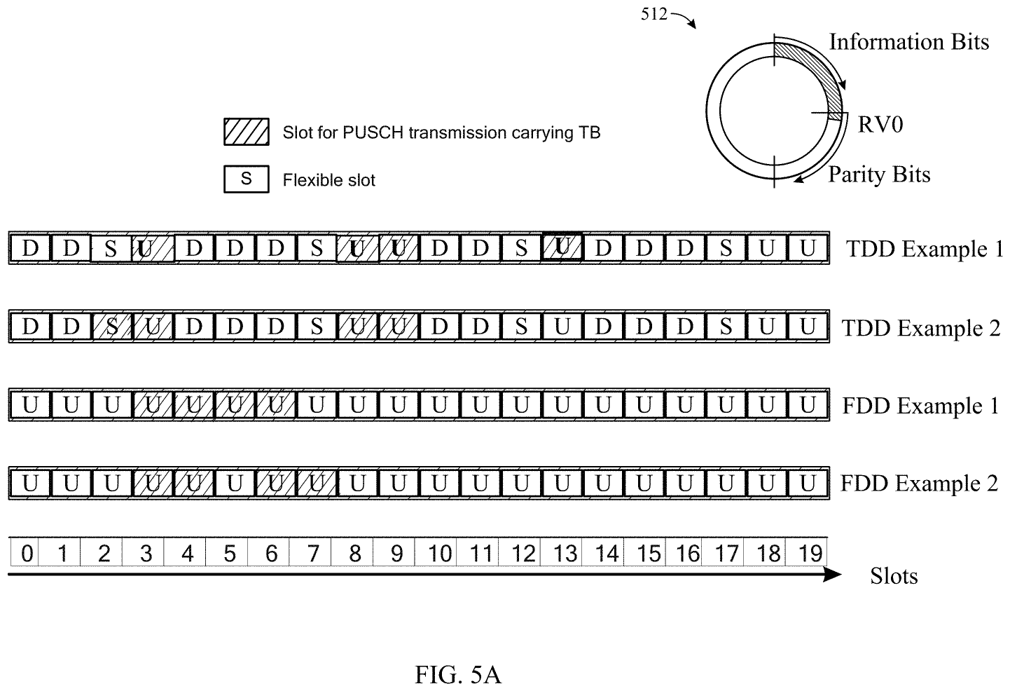

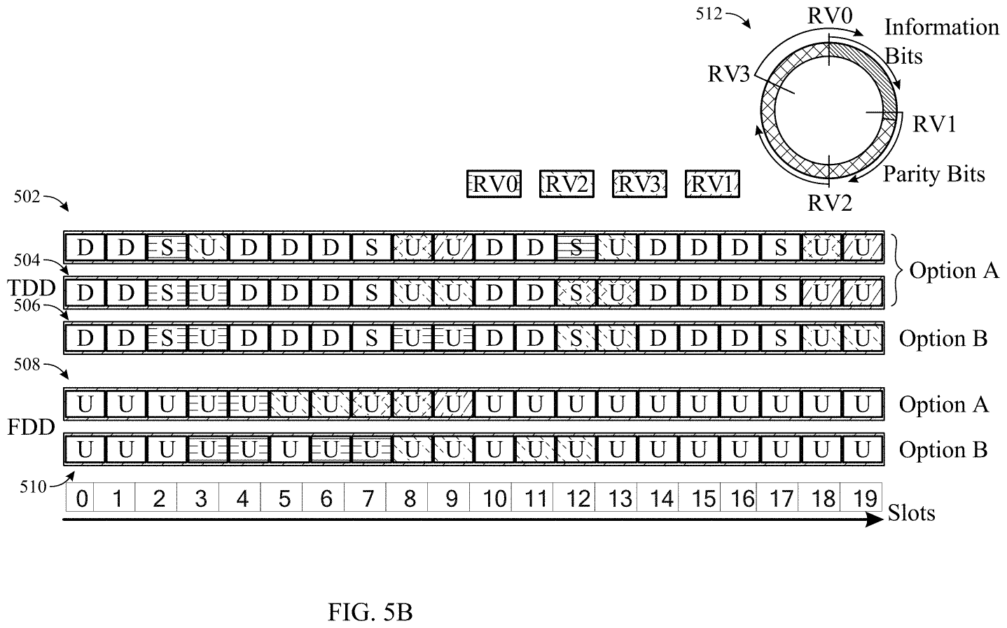

FIG. 5A is a slot diagram illustrating various TDD example cases of TBoMS transmissions where Option A may be utilized. In each case, the UE may determine a transport block (TB) size based on resource allocation across multiple slots (e.g., 4 slots in the illustrated examples). In this example, the UE may encode the payload and transmit the encoded payload based on a single RV via PUSCH in multiple slots.

In the first example (TDD Example 1), the UE transmits the TB in slots 3, 8, 9, and 13. In the second example (TDD Example 2), the UE transmits the TB in slots 2, 3, 8, and 9. In the third example (TDD Example 3), the UE transmits the TB in consecutive slots 3, 4, 5, and 6. In the fourth example (TDD Example 4), the UE transmits the TB in slots 3, 4, 6, and 7.

FIG. 5B is a slot diagram illustrating various cases where Option A and Option B may be implemented in a TDD or frequency-division duplex (FDD) deployment, in accordance with certain aspects of the present disclosure. The RV sequence applied in these examples is RV0, RV2, RV3, and RV1 from the circular buffer 512. In TDD Example 502, each RV is contained in a separate slot under Option A. In TDD Example 504, each RV spans across two consecutive slots under Option A. In TDD Example 506, an RV spans across non-consecutive slots under Option B. In FDD Example 508, each RV spans across consecutive slots under Option A. In FDD Example 510, an RV spans across non-consecutive slots under Option B.

### Example Multi-Slot Transport Block Transmission with Frequency Hopping

Aspects of the present disclosure provide apparatus, methods, processing systems, and computer readable mediums for implementing multi-slot transport block (TB) transmissions over an uplink channel with frequency hopping.

The techniques described herein allow a UE and base station (e.g., gNB) to determine frequency resources for each of multiple transmissions of a TB (e.g., across multiple slots in a PUSCH). In some cases, the location of frequency resources for any given transmission may be determined based on a particular slot (e.g., slot index) or transmission occasion (e.g., transmission occasion index) in which the transmission is sent.

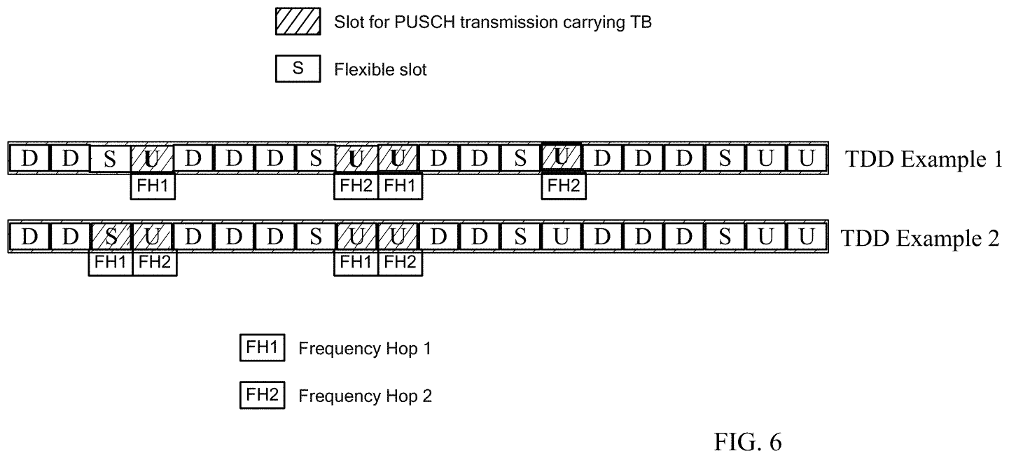

FIG. 6 illustrates how frequency hopping may be used in the first two examples shown in FIG. 5A. As shown, for TDD example 1, a first frequency hopping resource may be used for the transmissions on slots 3 and 9, while a second frequency hopping resource may be used for the transmissions on slots 8 and 13. Similarly, for TDD example 2, the first frequency hopping resource may be used for the transmissions on slots 2 and 8, while a second frequency hopping resource may be used for the transmissions on slots 3 and 9.

Frequency hopping within a TBoMS transmission in this manner may improve performance of the transmission, with frequency diversity. The present disclosure also provides various options for how to enable the frequency hopping within a TBoMS transmission and how to determine the frequency resources for each hop.

FIG. 7 is a flow diagram illustrating example operations 700 for wireless communication, in accordance with certain aspects of the present disclosure. The operations 700 may be performed, for example, by a UE (such as the UE 120a in the wireless communication network 100). The operations 700 may be implemented as software components that are executed and run on one or more processors (e.g., controller/processor 280 of FIG. 2). Further, the transmission and reception of signals by the UE in operations 700 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 700 begin, at 702, by receiving scheduling for at least one transport block to be transmitted over multiple slots.

At 704, the UE transmits the transport block on multiple transmission occasions over the multiple slots, in accordance with frequency hopping applied to vary frequency resources used across transmission occasions. Each transmission may be over a physical UL channel, such as a physical uplink shared channel (PUSCH).

FIG. 8 is a flow diagram illustrating example operations 800 for wireless communication, in accordance with certain aspects of the present disclosure. The operations 800 may be performed, for example, by a network entity (such as the BS 110a in the wireless communication network 100). The operations 800 may be complementary to the operations 700 performed by the UE. The operations 800 may be implemented as software components that are executed and run on one or more processors (e.g., controller/processor 240 of FIG. 2). Further, the transmission and reception of signals by the network entity in operations 800 may be enabled, for example, by one or more antennas (e.g., antennas 234 of FIG. 2). In certain aspects, the transmission and/or reception of signals by the network entity may be implemented via a bus interface of one or more processors (e.g., controller/processor 240) obtaining and/or outputting signals. As used herein, the network entity may refer to a wireless communication device in a radio access network, such as a base station, a remote radio head or antenna panel in communication with a base station, and/or network controller.

The operations 800 begin, at 802, by transmitting, to a user equipment (UE), signaling scheduling the UE to transmit at least one transport block over multiple slots.

At 804, the network entity monitors for the transport block on multiple transmission occasions over the multiple slots, in accordance with frequency hopping applied to vary frequency resources used across transmission occasions.

In some cases, the frequency hopping may be determined based on a TBoMS transmission occasion. Depending on the configuration, frequency hopping could occur across slots (inter-slot) or across transmission occasions (inter TO). A TO generally refers to resources available for a TBoMS transmission. While examples described herein and illustrated in the figures show single slot TOs, a TO may span multiple slots. Thus, frequency hopping can be applied within a TO, and this is referred to herein as intra-TO frequency hopping.

When TBoMS transmission is configured, the frequency hop for a TBoMS transmission occasion may be determined based on the TBoMS transmission occasion (TO) index or a logical scheduled slot index.

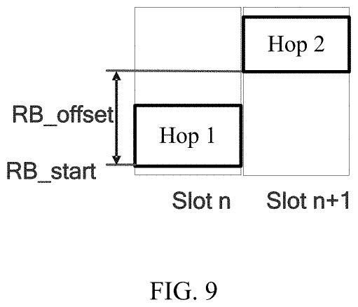

FIG. 9 illustrates an example of frequency hopping across slots. As illustrated, the frequency resources in each slot may be defined by a starting resource block (RBₛₜₐᵣₜ) within the UL BWP, as calculated from the resource block assignment information of resource allocation, and an offset value RB_{offset}. RB_{offset} is the frequency offset in RBs between the two frequency hops (adjacent slots in this example). The starting RB for the nth TBoMS transmission occasion or nth logical scheduled slot may be given by the following equation:

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} ,$$

such that the starting RB for even slots n (assuming n is even) is RBₛₜₐᵣₜ, while the starting RB for odd slots n+1 is RBₛₜₐᵣₜ+RB_{offset}.

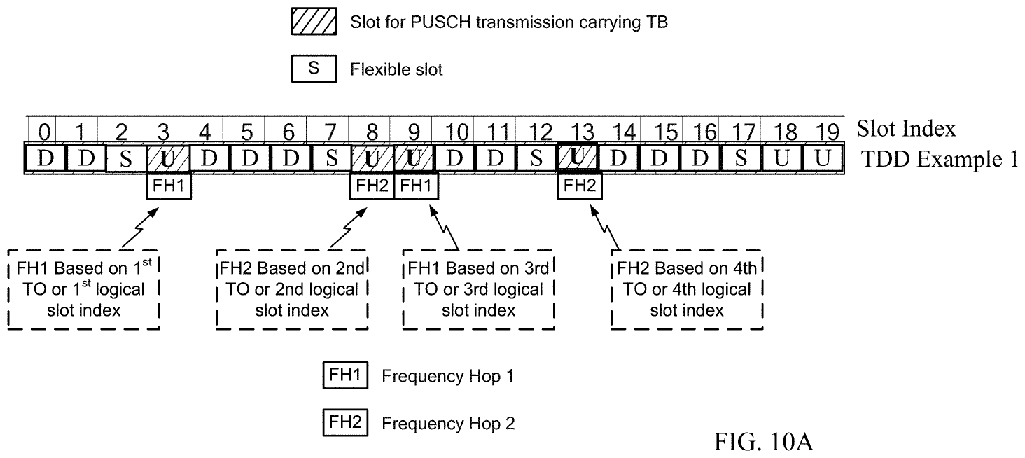

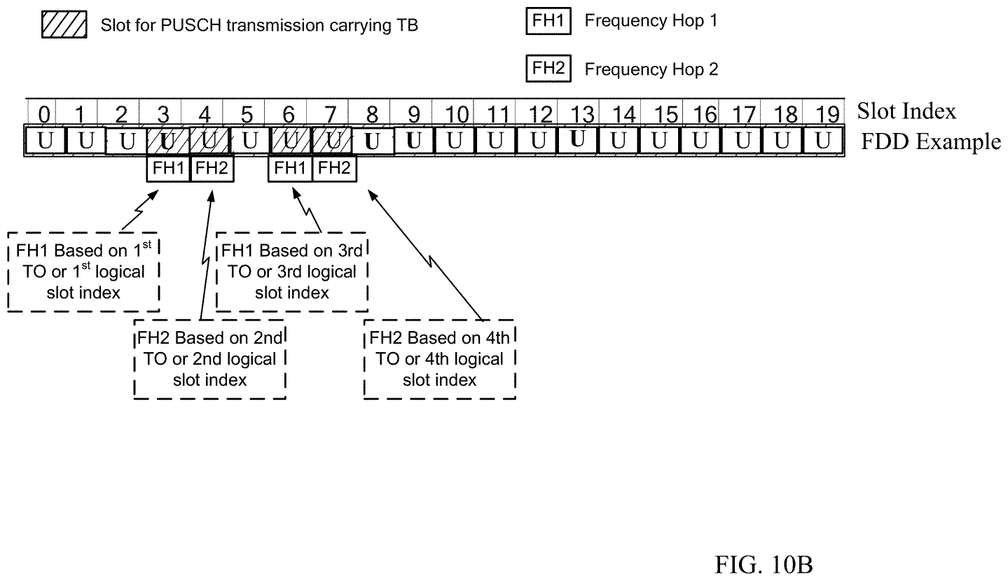

FIG. 10A illustrates an example of how frequency hopping, according to the equation above, may be performed for TDD Example 1 shown in FIG. 5A. As illustrated, odd transmission occasions (the 1^{st} and 3^{rd} TOs in slots 3 and 9) or logical slot indexes use frequency hop 1, while even transmission occasions (the 2^{nd} and 4^{th} TOs in slots 8 and 13) or logical slot indexes use frequency hop 2.

FIG. 10B illustrates an example of how frequency hopping, according to the equation above, may be performed for the FDD Example shown in FIG. 5A. As illustrated, odd transmission occasions (the 1^{st} and 3^{rd} TOs in slots 3 and 6) use frequency hop 1, while even transmission occasions (the 2^{nd} and 4^{th} TOs in slots 4 and 7) use frequency hop 2.

As demonstrated by the examples shown in FIGS. 10A and 10B, definitions for a slot index may refer to a physical slot index or a logical slot index. In TDD Example 1 of FIG. 10A, for example, the physical slot index for the transmission in 2nd TO is 8, while the logical slot index is 1 (with indexes starting with 0 as shown).

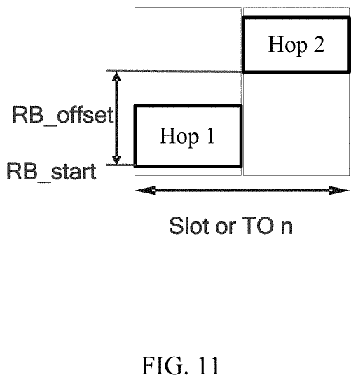

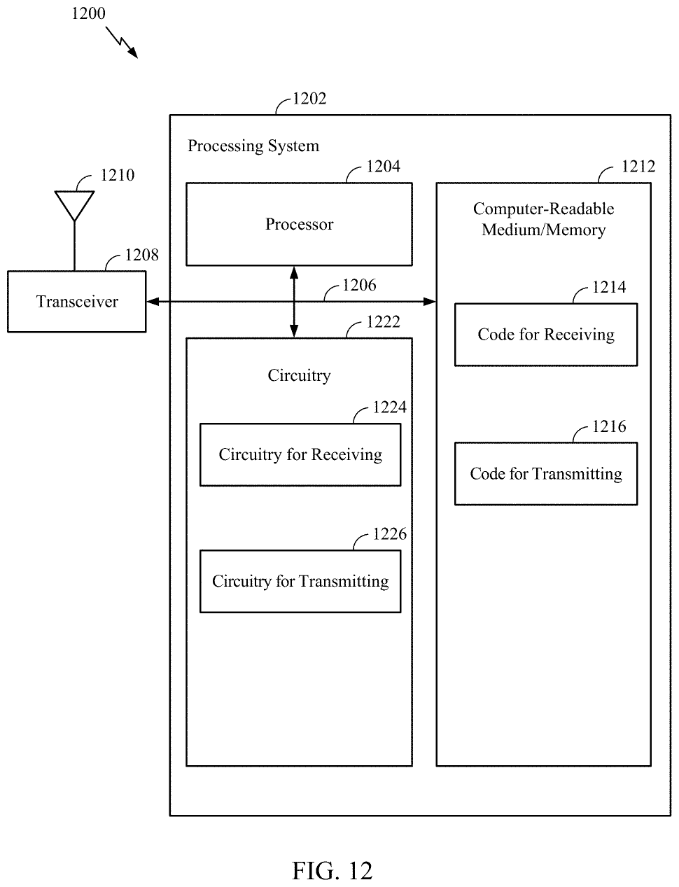

As illustrated in FIG. 11, in some cases, frequency hopping could occur within slots (intra-slot) or within a transmission occasions (intra TO). As with the inter-slot (or inter-TO) example described above, the frequency resources for each intra-slot (or intra-TO) hop may be defined by a starting resource block (RBₛₜₐᵣₜ) and offset value RB_{offset}. In this manner, the frequency resources may be varied within a TB transmission.

In some cases, when a UE is configured for TBoMS transmission, intra-slot or intra-TO frequency hopping can be configured for the TBoMS transmission. For some cases, when a UE is configured for TBoMS transmission, only intra-TO or inter-TO frequency hopping can be configured for the TBoMS transmission.

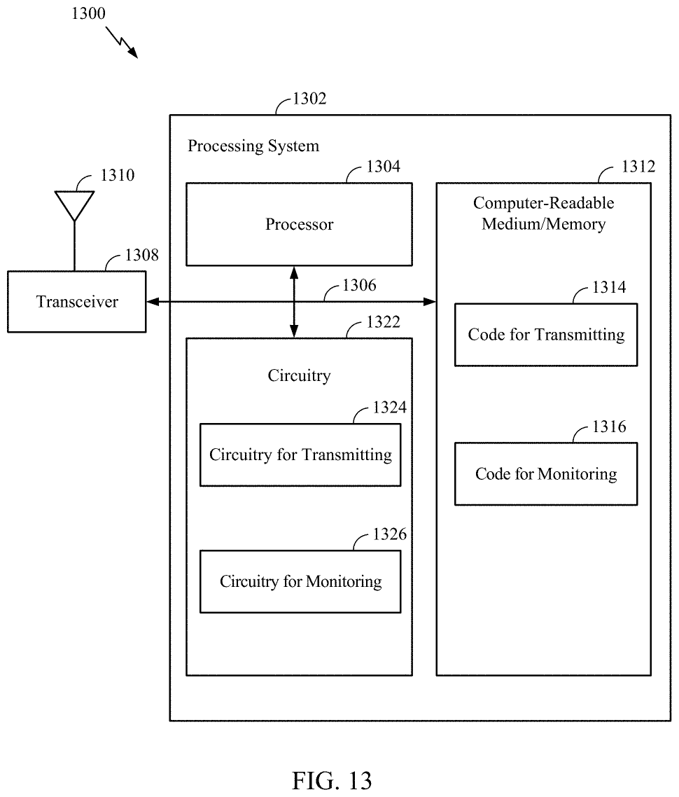

FIG. 13 illustrates a communications device 1300 (e.g., a UE) that may include various components (e.g., corresponding to means-plus-function components) configured to perform operations for the techniques disclosed herein, such as the operations illustrated in FIG. 7. The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 7, or other operations for performing the various techniques discussed herein for implementing multi-slot TB transmissions with frequency hopping. In certain aspects, computer-readable medium/memory 1312 stores code for receiving 1314 and code for transmitting 1316. In certain aspects, the processing system 1302 has circuitry 1322 configured to implement the code stored in the computer-readable medium/memory 1312. In certain aspects, the circuitry 1322 is coupled to the processor 1304 and/or the computer-readable medium/memory 1312 via the bus 1306. For example, the circuitry 1322 includes circuitry for receiving 1324 and circuitry for transmitting 1326.

FIG. 14 illustrates a communications device 1400 (e.g., a BS) that may include various components (e.g., corresponding to means-plus-function components) configured to perform operations for the techniques disclosed herein, such as the operations illustrated in FIG. 8. The communications device 1400 includes a processing system 1402 coupled to a transceiver 1408 (e.g., a transmitter and/or a receiver). The transceiver 1408 is configured to transmit and receive signals for the communications device 1400 via an antenna 1410, such as the various signals as described herein. The processing system 1402 may be configured to perform processing functions for the communications device 1400, including processing signals received and/or to be transmitted by the communications device 1400.

The processing system 1402 includes a processor 1404 coupled to a computer-readable medium/memory 1412 via a bus 1406. In certain aspects, the computer-readable medium/memory 1412 is configured to store instructions (e.g., computer-executable code) that when executed by the processor 1404, cause the processor 1404 to perform the operations illustrated in FIG. 8, or other operations for performing the various techniques discussed herein for configuring a UE for multi-slot TB transmissions with frequency hopping. In certain aspects, computer-readable medium/memory 1412 stores code for transmitting 1414 and/or code for monitoring 1416. In certain aspects, the processing system 1402 has circuitry 1422 configured to implement the code stored in the computer-readable medium/memory 1412. In certain aspects, the circuitry 1422 is coupled to the processor 1404 and/or the computer-readable medium/memory 1412 via the bus 1406. For example, the circuitry 1422 includes circuitry for transmitting 1424 and/or circuitry for monitoring 1426.

### Example Aspects

In addition to the various aspects described above, specific combinations of aspects are within the scope of the disclosure, some of which are detailed below:

Aspect 1: A method of wireless communication by a user equipment (UE), comprising: receiving scheduling for at least one transport block to be transmitted over multiple slots; and transmitting encoded bits corresponding to the transport block on multiple transmission occasions over the multiple slots, in accordance with frequency hopping applied to vary frequency resources used across transmission occasions.

Aspect 2: The method of Aspect 1, wherein the transmitting comprises transmitting the encoded bits corresponding to the transport block on multiple transmission occasions over physical uplink channels.

Aspect 3: The method of any one of Aspects 1-2, wherein the frequency resources used for a given transmission occasion are determined based on a transmission occasion index, a physical slot index or a logical slot index.

Aspect 4: The method of Aspect 3, wherein the frequency resources used for a given transmission occasion are determined as a function of: a starting frequency location, an offset frequency, and a transmission occasion index or a slot index.

Aspect 5: The method of any one of Aspects 1-4, wherein a starting location of the frequency resources used in adjacent transmission occasions differs by the offset frequency.

Aspect 6: The method of any one of Aspects 1-5, further comprising receiving signaling configuring the UE to perform frequency hopping within a slot or within a transmission occasion.

Aspect 7: The method of any one of Aspects 1-6, further comprising receiving signaling configuring the UE to perform frequency hopping within transmission occasions or across transmission occasions.

Aspect 8: The method of Aspect 7, further comprising receiving signaling configuring the UE to perform intra-slot frequency hopping or inter-slot frequency hopping.

Aspect 9: A method of wireless communication by a network entity, comprising: transmitting, to a user equipment (UE), signaling scheduling the UE to transmit at least one transport block over multiple slots; and monitoring for encoded bits corresponding to the transport block on multiple transmission occasions over the multiple slots, in accordance with frequency hopping applied to vary frequency resources used across transmission occasions.

Aspect 10: The method of Aspect 9, wherein the monitoring comprises monitoring for the encoded bits corresponding to the transport block on multiple transmission occasions over physical uplink channels.

Aspect 11: The method of any one of Aspects 9-10, wherein the frequency resources used for a given transmission occasion are determined based on a transmission occasion index, a physical slot index, or a logical slot index.

Aspect 12: The method of Aspect 11, wherein the frequency resources used for a given transmission occasion are determined as a function of: a starting frequency location, an offset frequency, and a transmission occasion index or a slot index.

Aspect 13: The method of any one of Aspects 9-12, wherein a starting location of the frequency resources used in adjacent transmission occasions differs by the offset frequency.

Aspect 14: The method of any one of Aspects 9-13, further comprising transmitting signaling configuring the UE to perform frequency hopping within a slot or within a transmission occasion.

Aspect 15: The method of any one of Aspects 9-14, further comprising transmitting signaling configuring the UE to perform frequency hopping within transmission occasions or across transmission occasions.

Aspect 16: The method of Aspect 15, further comprising transmitting signaling configuring the UE to perform intra-slot frequency hopping or inter-slot frequency hopping.

Aspect 17: An apparatus, comprising: a memory comprising computer-executable instructions; one or more processors configured to execute the computer-executable instructions and cause the processing system to perform a method in accordance with any one of Aspects 1-16.

Aspect 18: An apparatus, comprising means for performing a method in accordance with any one of Aspects 1-16.

Aspect 19: A non-transitory computer-readable medium comprising computer-executable instructions that, when executed by one or more processors of a processing system, cause the processing system to perform a method in accordance with any one of Aspects 1-16.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another. In other words, unless a specific order of steps or actions is specified, the order and/or use of specific steps and/or actions may be modified.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, a digital signal processor (DSP), an application specific integrated circuit (ASIC), or a processor (e.g., a general purpose or specifically programmed processor). Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above can also be considered as examples of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 7 and/or FIG. 8.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above.

1. A method of wireless communication by a user equipment (UE), comprising:
receiving scheduling for at least one transport block to be transmitted over multiple slots; and
transmitting encoded bits corresponding to the transport block on multiple transmission occasions over the multiple slots, in accordance with frequency hopping applied to vary frequency resources used across transmission occasions.

2. The method of claim 1, wherein the transmitting comprises transmitting the encoded bits corresponding to the transport block on multiple transmission occasions over physical uplink channels.

3. The method of claim 1, wherein the frequency resources used for a given transmission occasion are determined based on a transmission occasion index, a physical slot index or a logical slot index.

4. The method of claim 3, wherein the frequency resources used for a given transmission occasion are determined as a function of: a starting frequency location, an offset frequency, and a transmission occasion index or a slot index.

5. The method of claim 1, wherein a starting location of the frequency resources used in adjacent transmission occasions differs by the offset frequency.

6. The method of claim 1, further comprising receiving signaling configuring the UE to perform frequency hopping within a slot or within a transmission occasion.

7. The method of claim 1, further comprising receiving signaling configuring the UE to perform frequency hopping within transmission occasions or across transmission occasions.

8. The method of claim 7, further comprising receiving signaling configuring the UE to perform intra-slot frequency hopping or inter-slot frequency hopping.

9. A method of wireless communication by a network entity, comprising:
transmitting, to a user equipment (UE), signaling scheduling the UE to transmit at least one transport block over multiple slots; and
monitoring for encoded bits corresponding to the transport block on multiple transmission occasions over the multiple slots, in accordance with frequency hopping applied to vary frequency resources used across transmission occasions.

10. The method of claim 9, wherein the monitoring comprises monitoring for the encoded bits corresponding to the transport block on multiple transmission occasions over physical uplink channels.

11. The method of claim 9, wherein the frequency resources used for a given transmission occasion are determined based on a transmission occasion index, a physical slot index, or a logical slot index.

12. The method of claim 11, wherein the frequency resources used for a given transmission occasion are determined as a function of: a starting frequency location, an offset frequency, and a transmission occasion index or a slot index.

13. The method of claim 9, wherein a starting location of the frequency resources used in adjacent transmission occasions differs by the offset frequency.

14. The method of claim 9, further comprising transmitting signaling configuring the UE to perform frequency hopping within a slot or within a transmission occasion.

15. The method of claim 9, further comprising transmitting signaling configuring the UE to perform frequency hopping within transmission occasions or across transmission occasions.

16. The method of claim 15, further comprising transmitting signaling configuring the UE to perform intra-slot frequency hopping or inter-slot frequency hopping.

17. An apparatus for wireless communication by a user equipment (UE), comprising at least one processor and a memory configured to:
receive scheduling for at least one transport block to be transmitted over multiple slots; and
transmit encoded bits corresponding to the transport block on multiple transmission occasions over the multiple slots, in accordance with frequency hopping applied to vary frequency resources used across transmission occasions.

18. The apparatus of claim 17, wherein the transmitting comprises transmitting the encoded bits corresponding to the transport block on multiple transmission occasions over physical uplink channels.

19. The apparatus of claim 17, wherein the frequency resources used for a given transmission occasion are determined based on a transmission occasion index, a physical slot index or a logical slot index.

20. The apparatus of claim 19, wherein the frequency resources used for a given transmission occasion are determined as a function of: a starting frequency location, an offset frequency, and a transmission occasion index or a slot index.

21. The apparatus of claim 17, wherein a starting location of the frequency resources used in adjacent transmission occasions differs by the offset frequency.

22. The apparatus of claim 17, wherein the at least one processor and the memory are further configured to receive signaling configuring the UE to perform frequency hopping within a slot or within a transmission occasion.

23. The apparatus of claim 17, wherein the at least one processor and the memory are further configured to receive signaling configuring the UE to perform frequency hopping within transmission occasions or across transmission occasions.

24. The apparatus of claim 23, wherein the at least one processor and the memory are further configured to receive signaling configuring the UE to perform intra-slot frequency hopping or inter-slot frequency hopping.

25. An apparatus of wireless communication by a network entity, comprising at least one processor and a memory configured to:
transmit, to a user equipment (UE), signaling scheduling the UE to transmit at least one transport block over multiple slots; and
monitor for encoded bits corresponding to the transport block on multiple transmission occasions over the multiple slots, in accordance with frequency hopping applied to vary frequency resources used across transmission occasions.

26. The apparatus of claim 25, wherein the monitoring comprises monitoring for the encoded bits corresponding to the transport block on multiple transmission occasions over physical uplink channels.

27. The apparatus of claim 25, wherein the frequency resources used for a given transmission occasion are determined based on a transmission occasion index, a physical slot index, or a logical slot index.

28. The apparatus of claim 27, wherein the frequency resources used for a given transmission occasion are determined as a function of: a starting frequency location, an offset frequency, and a transmission occasion index or a slot index.

29. The apparatus of claim 25, wherein a starting location of the frequency resources used in adjacent transmission occasions differs by the offset frequency.

30. The apparatus of claim 25, wherein the at least one processor and the memory are further configured to transmit signaling configuring the UE to perform frequency hopping within a slot or within a transmission occasion.
